(19) United States
(12) Patent Application Publication
(10) Pub. No.: US 2015/0151321 A1
(43) Pub. Date: Jun. 4, 2015

(54) METHOD FOR PRODUCING A BEVEL, COMPONENT HAVING A BEVEL AND APPARATUS

(71) Applicant: SIEMENS AKTIENGESELLSCHAFT, Munchen (DE)

(72) Inventor: Tobias BRETT, Schonefeld (DE)

(21) Appl. No.: 14/554,543

(22) Filed: Nov. 26, 2014

(30) Foreign Application Priority Data
Nov. 29, 2013 (DE) 102013224568.8

(51) Int. Cl. B05B 15/04; B05D 1/32

(52) U.S. Cl. CPC B05B 15/0443; B05B 15/045; B05D 1/32

(57) ABSTRACT

Shading apparatus cause spray coating of a substrate (4) to define a bevel (10) in the coating (22) in the region of an edge (13) of the substrate, such that there is a low-stress transition at the intersection between the surface (25) on which the shading apparatus is supported and is not to be coated and the surface (7) which is to be coated; the shading apparatus protrudes above and shades the edge region of the surface to be coated.

### CROSS-REFERENCE TO RELATED APPLICATIONS

The present application claims priority of European Patent Application No. 102013224568.8, filed Nov. 29, 2013, the contents of which are incorporated by reference herein.

### BACKGROUND OF THE INVENTION

The invention relates to a coating method, in which a bevel is produced on a surface of a component which is to be coated, and to a corresponding component and apparatus for performing the method.

Components for use at high temperature are often provided with metallic and/or ceramic protective layers.

In particular, overhangs are formed at edges, and these have to be set very precisely.

This is time-consuming and difficult to produce.

It is therefore an object of the invention to specify a method, a component and an apparatus which eliminate such problems.

The invention makes it possible to produce bevels on a coated surface and improved components in a simple manner.

### BRIEF DESCRIPTION OF THE DRAWINGS

In the drawing:

FIGS. 1, 2 and 3 show a component and the procedure for the component during the coating, and

FIG. 4 shows a turbine blade or vane.

### DESCRIPTION OF EMBODIMENT

The figures and the description represent only exemplary embodiments of the invention.

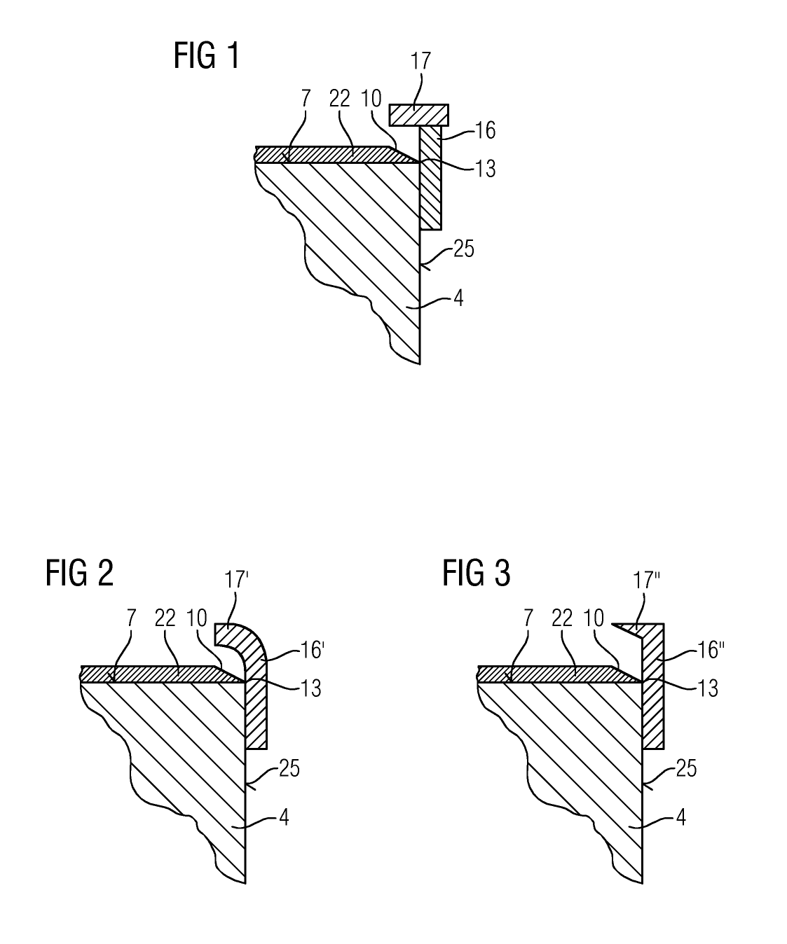

FIG. 1 shows a substrate 4 having a surface 7 which is to be coated and a surface 25 which is not to be coated. The substrate 4 has an edge 13 between the surface 7 which is to be coated and the surface 25 which is not to be coated. The surface 25 intersects the surface 7 at the edge 13. That edge preferably has a rectangular form.

The substrate 4 is preferably metallic.

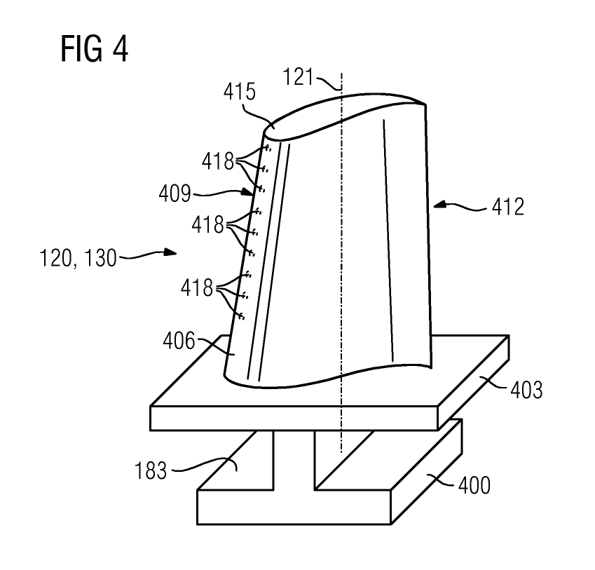

In the case of turbine blades or vanes 120, 130 (FIG. 4), the substrate 4 may comprise a nickel-based or cobalt-based superalloy.

If the substrate 4 to be coated is a turbine blade or vane 120, 130, the face 7 which is to be coated is at least the platform 403 (FIG. 4), and the surface 25 which is not to be coated is a side face of the platform 403.

At least one coating 22 consisting of a metal, in particular of an MCrAlY alloy, and/or of a ceramic is produced on the face 7 to be coated.

A bevel 10 is present in the coating 22 and particularly only in the coating 22 in the region of the edge 13 The bevel represents a chamfer of the coating 22 that tapers toward the edge 13. The bevel 10 ends at the edge 13.

During the coating process, use is made for the coating of a changing plate 16, which bears directly against that surface 25 which is not to be coated and also protrudes beyond the surface 7 which is to be coated and particularly in the longitudinal direction 121 (FIG. 4) of the component 4, 120, 130.

The end of the changing plate 16 is preferably provided with an overhang, preferably transverse to the changing plate 16, such as a short crossbar 17, which furthermore shades the substrate 4 in the region of the edge 13 and preferably protrudes beyond the edge 13.

During the coating process, less coating material is applied in the region of the edge 13 even by virtue of the changing plate 16 alone. This is preferably reinforced by the short crossbar 17. As a result the bevel 10 is produced.

Alternatively and similarly, the end 17′ of the changing plate 16 can be bent toward the coated component 4 (FIG. 2).

As a further alternative, the protruding end of the changing plate 16 can have an extension 17″ (FIG. 3). The angle of the thickened portion 17″ is preferably 40°, and the thickened portion preferably has a height of 1.5 mm.

HVOF, plasma spraying processes such as APS and LPPS, or other thermal spraying processes or vacuum processes are used here with preference.

The crossbar 17, the end 17 or the extension 17″ effectively shade the region of the surface 7 to be coated inward from the edge 13, causing less of the sprayed on coating to deposit on the surface 7 closer to the edge 13 of the substrate and thereby creating a bevel which tapers toward the edge. The bevel stops at the surface 25, where the plate blocks spraying of coating beyond the surface 25 and the edge 13.

This gives rise in general to a low-stress transition between the coating 7 and the edge 13 and the surface 25 which is not to be coated.

FIG. 4 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, for example, solid metallic materials, in particular superalloys, are used in all regions 400, 403, 406 of the blade or vane 120, 130. Superalloys of this type are known, for example, from EP 1 204 776 B1, EP 1 306 454, EP 1 319 729 A1, WO 99/67435 or WO 00/44949. The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation, e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density. A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1. A method for producing a coating on a face of a substrate wherein the coating has a bevel at a margin of the coating located on an edge of the face of the substrate which is to be coated, and wherein the bevel in the coating ends in the region of the edge of the face;
wherein the substrate includes the face to be coated and includes a surface which is not to be coated, wherein the not to be coated face intersects the face to be coated at the edge of the substrate;
the method comprising:
applying a plate to the surface of the substrate which is not to be coated plate to protrude in its longitudinal direction, past the edge and beyond the face of the substrate which is to be coated; and
the plate is so shaped that when the plate is applied to the surface not to be coated, the plate includes a part thereof that is spaced above and overhangs the face to be coated extending from the edge partially over the face to be coated; and
the method further comprising coating the face of the substrate while partially blocking the coating getting to the face toward the edge of the face of the substrate, for forming a bevel tapering toward the edge.

2. The method as claimed in claim 1, further comprising:
arranging the overhang at the end of the plate, so that the overhang projects from the edge in the direction over and above the face to be coated, and protruding above the edge, but partially and not completely projecting over the face to be coated.

3. A component, produced according to the method as claimed in claim 1, in which the component has a face which is to be coated and a surface which is not to be coated, wherein the surface intersects the face at an edge and the coating is formed on the face and is formed with a bevel in the region of the coating at the edge, and the bevel of the coating tapering shorter in height toward the edge.

4. The component as claimed in claim 3, in which the coating is a metallic and/or ceramic coating.

5. The component as claimed in claim 3, wherein a substrate of the component is metallic.

6. The component as claimed in claim 3, wherein the bevel is formed only in the coating on the face of the substrate and toward the edge.

7. An apparatus for carrying out a process as claimed in claim 1, the apparatus having a mount for a substrate of the component;
the substrate having a face to be coated;
a plate, applied directly to a surface of the substrate which is not to be coated at and above an intersection of the face to be coated with the surface not to be coated.

8. The apparatus as claimed in claim 7, further comprising an overhang arranged at an end of the plate and spaced above the face to be coated; and
the overhang projecting in a direction of the surface to be coated, by protruding above and beyond the edge and the edge is between the face to be coated and the surface not to be coated.

9. The apparatus as claimed in claim 8, wherein the overhang spaced above the face to be coated is a crossbar on the plate.

10. The apparatus as claimed in claim 9, in which the overhang spaced above the face to be coated is a bend of an end of the changing plate.

11. The apparatus as claimed in claim 9, in which the overhang spaced above the face to be coated is an extension of the end of the changing plate.

12. The component as claimed in claim 3, wherein the edge is a rectangular edge.
